(19) United States
(12) Patent Application Publication
(10) Pub. No.: US 2022/0149698 A1
(43) Pub. Date: May 12, 2022

(54) REGENERATIVE ENERGY SYSTEM

(71) Applicant: Ashot Salvaryan, Sun Valley, CA (US)

(72) Inventor: Ashot Salvaryan, Sun Valley, CA (US)

(21) Appl. No.: 17/521,816

(22) Filed: Nov. 8, 2021

Related U.S. Application Data
(60) Provisional application No. 63/110,849, filed on Nov. 6, 2020.

(51) Int. Cl. H02K 7/18; H02K 7/06; F03G 7/10; F03B 13/22

(52) U.S. Cl. CPC H02K 7/1853; F03B 13/22; F03G 7/115; H02K 7/06

(57) ABSTRACT

The present invention is a system and method for recovering the kinetic energy associated with the movement of a vehicle frame relative to the vehicle suspension to generate electrical energy that may be stored in order to power vehicle systems, wherein in a first embodiment a regenerative energy system uses a gear assembly to convert linear up-and-down movement of the vehicle suspension to rotary motion that is then utilized by a rotational movement capture system to force movement of one or more alternators in a single direction to thereby generate electricity that may be stored in batteries or supercapacitors.

### BACKGROUND

### Field of the Invention

This invention relates generally to power generation systems. More specifically, the invention pertains to a system for reclaiming kinetic energy that is generated by the movement of a vehicle as it is traveling, and even more specifically from the vibrations that are experienced by a vehicle suspension system.

### Description of Related Art

The prior art includes various examples of kinetic energy recovery systems that are specifically designed as components of a vehicle, and which are capable of generating electrical energy that may also be used by a vehicle.

One example of the prior art teaches a piston type pump that is mounted between a vehicle frame and the suspension. The pump charges a high-pressure accumulator for driving hydraulic motors, e.g., power windows, power seats, alternator, etc.

In another embodiment, electricity is generated directly by a conductor moving with respect to magnetic field as a result of the up and down motion of the vehicle suspension.

In another invention, an air compressor mounted between the vehicle frame and suspension compresses air for storage in a pressure tank and is used to power pneumatic devices.

Another document in the prior art teaches an energy regeneration device that is disposed within a chassis spring of a suspension system that transforms kinetic energy generated by elongation and compression of the chassis spring to electrical energy by the piezo electrical effect. A suspension device of a vehicle is provided with one or more links for connecting to a vehicle body which is supported using a chassis spring and a shock absorber, and it can modulate horizontal relative movement of a vehicle body and a wheel by modulating rigidity and flexibility.

The invention described above includes a transforming body configured to be compressed or elongated by a chassis spring of the suspension system, and an electric generating member that is electrically connected and configured to be compressed or elongated with the transforming body.

The transforming body is disposed between coils of the chassis spring of the Suspension system. The electric generating members are aligned between adjacent pitches of the coils so that the electric generating members are compressed or elongated by relative movements of the coils.

The energy regeneration device also includes a rectifier that is electrically connected with the electric generating members through the connector and rectifies an electric current made by the electric generating members, where the electric generating member is a piezoelectric element.

What is clear from the prior art is that there appear to be many different ways of capturing the kinetic energy of movement within a vehicle suspension system and transforming it into usable mechanical and/or electrical energy.

However, it appears that the prior art systems are often too fragile to work consistently in the environment in which they operate because of conditions of the road. Furthermore, the amount of usable energy that is obtained is relatively small.

Accordingly, it would be an advantage over the prior art to provide a durable method of converting mechanical or kinetic energy into electrical energy. It would be a further advantage to create a two-step process, wherein a first step is to mechanically convert linear motion to rotational motion, and a second step is to more efficiently convert the rotational motion to electrical energy.

### BRIEF SUMMARY

The present invention is a system and method for recovering the kinetic energy associated with the movement of a vehicle frame relative to the vehicle suspension to generate electrical energy that may be stored in order to power vehicle systems, wherein in a first embodiment a regenerative energy system uses a gear assembly to convert linear up-and-down movement of the vehicle suspension to rotary motion that is then utilized by a rotational movement capture system to force movement of one or more alternators in a single direction to thereby generate electricity that may be stored in batteries or supercapacitors.

In a first aspect of the invention, it is an object of the present invention to provide a method and system of recovering the kinetic energy associated with the movement of a vehicle frame relative to the vehicle suspension to generate electrical energy that may be stored and used for vehicle systems.

In a second aspect of the invention, a rack and pinion system may be used to mechanically convert linear motion to rotational motion of a main shaft.

In a third aspect of the invention, the rotational motion of the main shaft may then be directed to an alternator to thereby enable rotational motion to generate electrical energy that may be used at that moment, stored for future use, or both.

In a fourth aspect of the invention, the electrical energy generated by the embodiments of the invention is stored so that it may be used by a vehicle that at least partially uses electrical motors to power the motion of the tires.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of the first embodiment of the invention.

FIG. 2A is a profile view of the components of a rack and pinion gear assembly of the invention.

FIG. 2B is a top view of the components of a rack and pinion gear assembly of the invention.

FIG. 3 is a top view of the components in a first embodiment of the invention.

FIG. 4 is a perspective view of the splines on the main shaft and inside the barrel screw.

FIG. 5 is a perspective view of the grooves on the outer diameter of the barrel screw that enables it to move back and forth relative to a stationary pin.

FIG. 6 is a perspective view of the barrel screw, the pin and the conical transfer springs attached at both ends of the barrel screw.

FIG. 7 is a perspective view of a conical transfer spring.

FIG. 8 is a perspective view of a main spring assembly, a one-way bearing, and a conical transfer spring.

FIG. 9 is a side view of the inside of the main spring assembly showing the main spring inside.

FIG. 10 is a top view of the components in a second embodiment of the invention.

FIG. 11 is a block diagram that shows how to connect a plurality of alternators in series to the embodiments of the present invention.

FIG. 12 is a top view of a vehicle chassis showing placement of the embodiments of the invention in order to capture energy from the vehicle suspension system and create electrical energy that may be used by a vehicle.

FIG. 13A is a top view of just a middle chassis section and components of the embodiments of the invention.

FIG. 13B is a profile view of the middle chassis section and components of the embodiments of the invention as shown in FIG. 13A.

FIG. 13C is a profile view of the middle chassis section and components of the embodiments of the invention as shown in FIG. 13A.

FIG. 13D is a top view of one possible arrangement of regenerative energy systems disposed on the middle chassis section.

FIG. 14 is a block diagram that shows that the electrical energy generated by the regenerative energy system may be stored in a battery or a supercapacitor.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

It is first useful to understand the source of kinetic energy of the embodiments of the invention. The source of kinetic energy is motion that is typically in an upward and downward direction that is constantly repeating. Such sources of energy may be represented by ocean waves or the up and down movement of a vehicle as it travels over a road. Thus, it should be understood that the present invention is capable of continuously capturing energy from repetitive motion of an object such as a vehicle or water.

While the embodiments of the invention are focused on capturing energy from the motion of a vehicle, it should be understood that the principles apply to capturing energy from any source of repetitive motion. There is also no limit on the type of motion that may be converted.

One practical application of the invention relates to the movement of a vehicle. The job of a vehicle suspension is to maximize the friction between tires and a road surface, to provide steering stability with good handling, and to ensure the comfort of the passengers. If a road were perfectly flat with no irregularities, suspensions would not be necessary. However, roads are far from flat. Even freshly paved highways have subtle imperfections that can interact with the wheels of a vehicle. These imperfections apply forces to the wheels. All forces have both magnitude and direction. Thus, a bump in the road causes the wheel to move up and down perpendicular to the road surface and the direction of travel. The magnitude of the force depends on whether the wheel is striking a large bump or a small one and the velocity of the wheel. Regardless, the wheel experiences a vertical acceleration as it passes over any roadway imperfection (sometimes also referred to herein as roadway irregularity).

Without an intervening structure, all of the wheel's vertical energy is transferred to the frame which moves in the same direction. In such a situation, the wheels may even lose contact with the road. Then, under the downward force of gravity, the wheels may slam back into the road surface.

Road isolation refers to the vehicle's ability to absorb or isolate road shock from the passenger compartment, thereby allowing the vehicle body to ride undisturbed while traveling over rough roads. The suspension absorbs energy from road bumps and dissipates the energy without causing undue oscillation in the vehicle.

The suspension of a car is actually part of the chassis, which includes all of the important systems located beneath the car's body. These systems include the frame, the suspension system, the steering system, and the tires and wheels. The frame supports the car's engine and body, which are, in turn, supported by the suspension. The suspension supports weight, absorbs and dampens shock, and helps maintain tire contact with the roadway. The steering system enables the driver to guide and direct the vehicle. The tires and wheels make vehicle motion possible by way of friction with the road. Whether loosely sprung or tightly sprung, the suspension of any vehicle is constantly moving relative to the frame.

Unless a dampening structure is present, a car spring will extend and release the energy it absorbs from a bump at an uncontrolled rate. The spring will continue to bounce at its natural frequency until all of the energy originally put into it is used up. A suspension built on springs alone would make for an extremely bouncy ride and, depending on the terrain, an uncontrollable vehicle. The shock absorber controls unwanted spring motion through a process known as dampening. Shock absorbers slow down and reduce the magnitude of vibratory motions by turning the kinetic energy of suspension movement into heat energy that can be dissipated through hydraulic fluid.

The vehicle suspension regenerative energy recovery system of the present invention generates useful energy from the up-and-down motion of a vehicle suspension caused by roadway irregularities as the vehicle travels down the road.

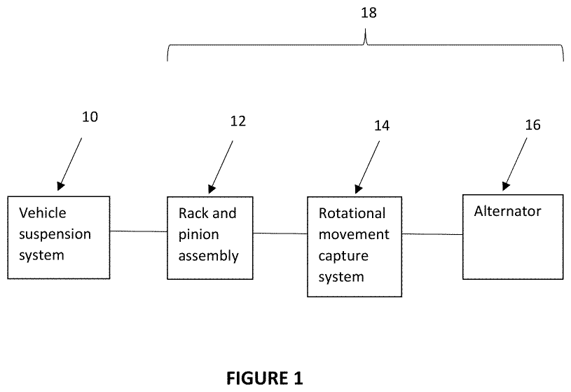

FIG. 1 is a block diagram of the components of a first embodiment of the present invention. The first embodiment is able to capture approximately half of the kinetic energy from the up-and-down motion of the vehicle suspension system. Assume that a portion of the vehicle suspension system 10 is capable of up-and-down movement in the direction of the arrows shown.

In the block diagram view in FIG. 1, a rack and pinion assembly 12 may be coupled to the vehicle suspension system 10. The rack and pinion assembly 12 is then coupled to a rotational movement capture system 14. The rotational movement capture system 14 is then coupled to an alternator 16 for generating electricity. The combination of the rack and pinion assembly 12, the rotational movement capture system 14, and the alternator 16 may be referred to as the regenerative energy system 18.

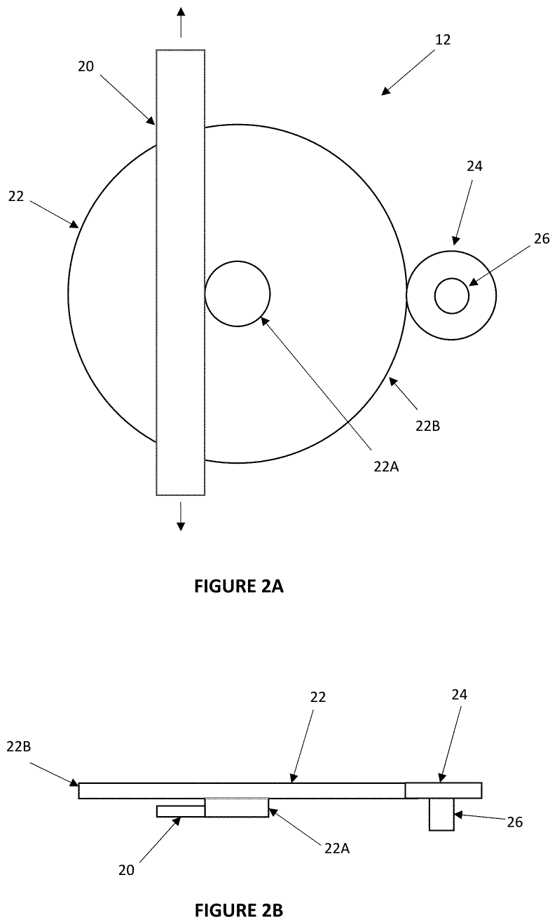

As shown in FIG. 2, the rack and pinion assembly 12 is a type of linear actuator that comprises a linear gear 20 (the rack) engaging a circular gear 22 (the pinion) having a small inner circular gear 22A and a large outer circular gear 22B, which operate to translate linear motion of the linear gear 20 into rotational motion of the circular gear 22. Thus, driving the linear gear 20 linearly as shown by the arrows will cause the circular gear 22 to be driven into a rotational movement. If the linear gear 20 is moving up and down, then the circular gear 22 will rotate in a first direction when the linear gear is moving up, and then reverse and rotate in an opposite direction when the linear gear is moving down.

FIG. 2 also shows an output gear 24. The rotation of the circular gear 22 in the rack and pinion assembly 12 may cause rotation of the output gear 24. The outer circular gear 22B may be much larger than the output gear 24 to thereby create larger movements. The gear ratio between the outer circular gear 22B and the output gear 24 may be 5:1.

It is noted that the circular gear 22 may be a step-up spur gear with a ratio of 1:5. The rotary motion of the circular gear 22 is then transferred onto a first portion 26 of the main shaft 30 using the output gear 24 using a step-down spur gear having a ratio of 5:1. However, it should be understood that these gear ratios are only an example and may be modified in order to meet the circumstances of the system and should not be read as limiting the scope of the claims. It should also be understood that the teeth on the linear gear 20, the circular gear 22 and the output gear 24 are not shown but are present, and that the exact thickness and length of the various gears and shafts are not shown to exact scale but are shown for illustration purposes only.

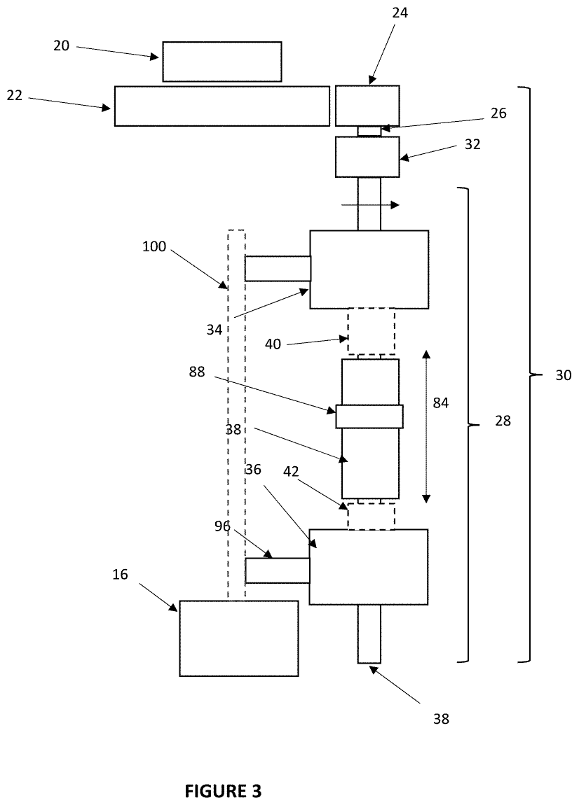

FIG. 3 is a block diagram that illustrates the components of the rack and pinion assembly 12 and the rotational movement capture system 14, and how these two systems are in communication.

The output gear 24 may be disposed on a first portion 26 of a main shaft 30. The first portion 26 of the main shaft 30 is able to rotate in both directions. The first portion 26 is then coupled to a second (and longer) portion 28 of the main shaft 30 using a coupling that is a one-way bearing 32. The one-way bearing 32 is also known as an anti-reverse bearing. One-way bearings are designed to transmit torque between a shaft and a housing in one direction and allow free motion in the opposite direction.

Accordingly, while the output gear 24 and the first portion 26 of the main shaft 30 will rotate in both directions, the second portion 28 of the main shaft 30 will only rotate in one direction. This means that the up-and-down motion of the vehicle suspension system 10 is only causing the main shaft 30 to rotate when the vehicle suspension system 10 moves up or when it moves down, but not from movement in both directions.

In other words, this first embodiment may only be capturing kinetic energy from half of the movement of the vehicle suspension system 10. This is because the second portion 28 of the main shaft 30 is only moving half of the time that the vehicle suspension system 10 is moving because of the use of the one-way bearing 32.

The function of the rack and pinion assembly 12 is to translate linear movement into rotational movement of the main shaft 30. The function of the one-way bearing 32 is to then make the rotational movement of the main shaft 30 move in a single direction. Then the main shaft 30 is coupled to the rotational movement capture system 14 in order to keep the alternator 16 in constant rotational motion in a single direction.

The rotational movement capture system 14 is comprised of several components that are all coupled to the main shaft 30. However, before explaining the components of the first embodiment, it should be stated that other types of systems may be used to provide the functionality of the rotational movement capture system 14. However, a particular advantage of the first embodiment as shown is that it is a purely mechanical system with few moving parts. By simplifying the components of the rotational movement capture system 14, the present invention provides an advantage over other systems that could also perform the same function. For example, the rotational movement capture system 14 could be implemented using electromagnetic, hydraulic, or pneumatic systems. However, these other systems are not as desirable because of difficulty of implementation and maintenance.

Accordingly, the functionality of the rotational movement capture system 14 is what is being claimed and not a specific implementation. However, the first embodiment of the invention describes in detail an implementation using a mechanical braking system.

The components of the rotational movement capture system 14 shown in the first embodiment as shown in FIG. 3. FIG. 3 is a top view looking down on the components of the rotational movement capture system 14. These components may include a first main spring assembly 34 at one end of the main shaft 30 and a second main spring assembly 36 at the opposite end of the main shaft. The first and second main spring assemblies 34, 36 are part of an energy storage system that is capturing energy from the movement of the main shaft 30 so that the shaft motion may be directed to the alternator 16.

The energy of the main shaft 30 is captured by turning it into potential energy that is stored in four springs: the two main springs 34, 36 and two conical transfer springs 40, 42. These springs enable the transfer of energy to the alternator 16. As shown in FIG. 3, there is a main spring and conical transfer spring at each end of a screw barrel mechanism 38. The self-reversing screw barrel mechanism 38 is disposed around the main shaft 30. The self-reversing screw barrel mechanism 38 moves left and right along the main shaft 30 as indicated by arrow 84. The self-reversing screw barrel mechanism 38 is confined to move only as far as the two conical transfer springs 40, 42. While one of the two conical transfer springs 40, 42 is winding up, the other is rapidly unwinding. Then their functions are reversed because of the change of direction of the self-reversing screw barrel mechanism 38.

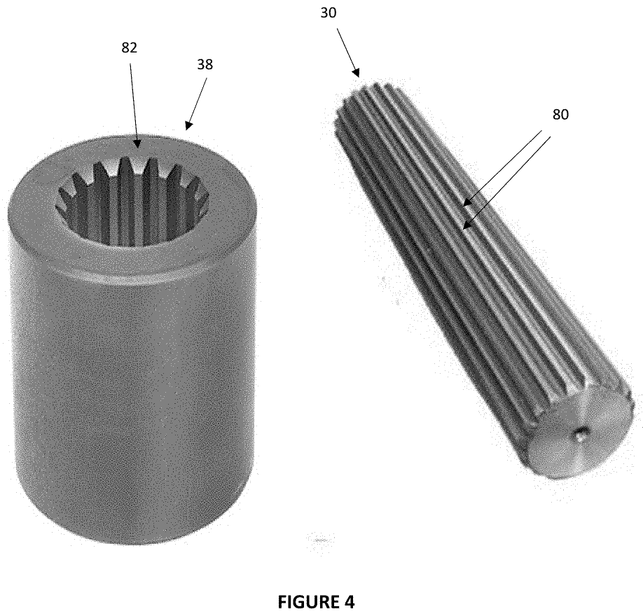

As shown in FIG. 4, the main shaft 30 is grooved with multiple splines 80 disposed along its length. These splines 80 slidingly engage corresponding splines 82 on the inner diameter of the self-reversing screw barrel mechanism 38. The main shaft 30 and the self-reversing screw barrel mechanism 38 are not shown to scale but only to illustrate the complementary splines 80, 82 in each device. The self-reversing screw barrel mechanism 38 is also shown without the typical grooves on its outer diameter.

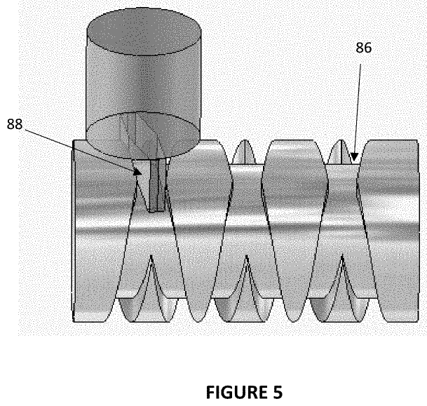

FIG. 5 is provided as an example of the type of grooves 86 disposed on the outer diameter of the self-reversing screw barrel mechanism 38 that enable the mechanism to reverse directions. FIG. 5 also shows a pin 88 disposed in the grooves 86. If the pin 88 is stationary and the self-reversing screw barrel mechanism 38 is turning in either direction, the barrel will move from one end to the other relative to the pin.

Returning to FIG. 3, it will be imagined that the self-reversing screw barrel mechanism 38 is presently moving toward the bottom of the page while the pin 88 remains stationary. Thus, the self-reversing screw barrel mechanism 38 is compressing or winding up the second conical transfer spring 42 while at the same time, the first conical transfer spring 40 is released and is unwinding rapidly.

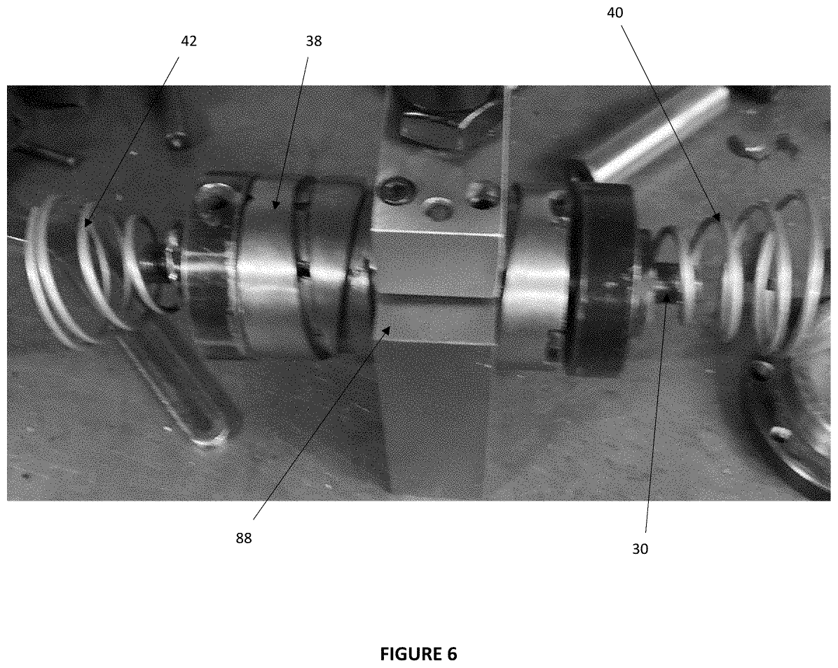

The first and second conical transfer springs 40, 42 are both connected to the self-reversing screw barrel mechanism 38 at opposite ends thereof. This is shown in FIG. 6, where the self-reversing screw barrel mechanism 38 is shown with the two conical transfer springs 40, 42 attached to both ends and the pin 88 shown as a large stationary block that hides the stationary pin that is engaging the self-reversing screw barrel mechanism 38.

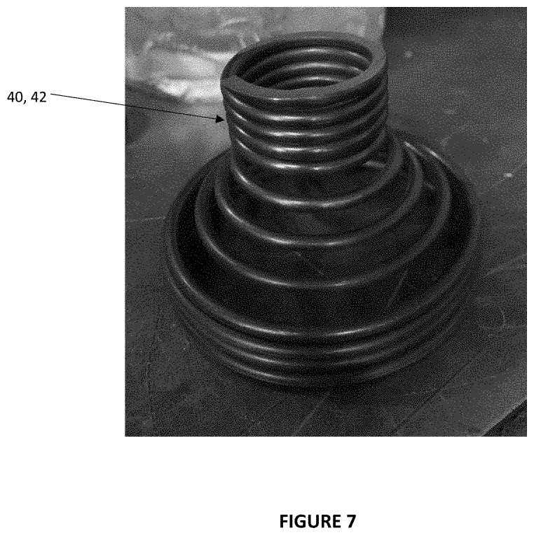

FIG. 7 is another view of the conical transfer springs at rest.

Returning to FIG. 3, as the main shaft 30 rotates in, for example, a clockwise direction so that the top of the main shaft that is visible is moving from left to right, the self-reversing screw barrel mechanism 38 is caused to rotate because of the complementary splines 80, 82 on the main shaft and the self-reversing screw barrel mechanism 38. Assuming that the self-reversing screw barrel mechanism 38 is moving down towards the bottom of the page, the second conical transfer spring 42 beings to wind tighter. It winds tighter because when the self-reversing screw barrel mechanism 38 moves toward a conical transfer spring, the conical transfer spring is also coupled to a one-way bearing 90. The one-way bearing 90 is disposed so that the bearing will not rotate on the main shaft 30 as the conical transfer spring is being compressed and wound tight. The energy of the main shaft 30 is now being transferred to the second conical transfer spring 42 because the one-way bearing.

It is noted that in contrast, the other conical transfer spring that is not being compressed is released and free to rapidly unwind when the self-reversing screw barrel mechanism 38 is moving away from it.

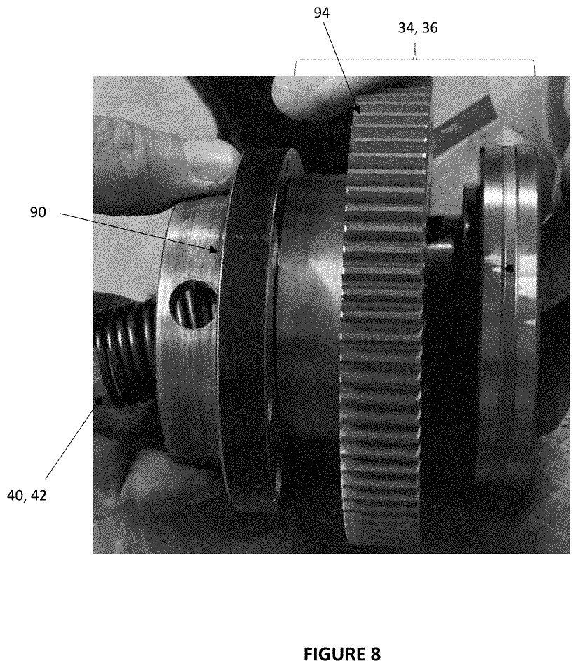

FIG. 8 shows a close-up view of a conical transfer spring 40, 42, a housing for the one-way bearing 90, and a housing for the main spring assemblies 34, 36. The conical transfer springs 40, 42 will be aligned with the axis of the main shaft 30. The main spring assemblies 34, 36 include a housing for a main spring 92 and an outer gear 94. The outer gear 94 is disposed so as to engage a transfer gear 96 that is also coupled to a gear of the alternator 16.

Another function of the main spring assemblies 34, 36 is to enable the free rotation of the outer gear 94 when the one-way bearing 90 is released to rotate.

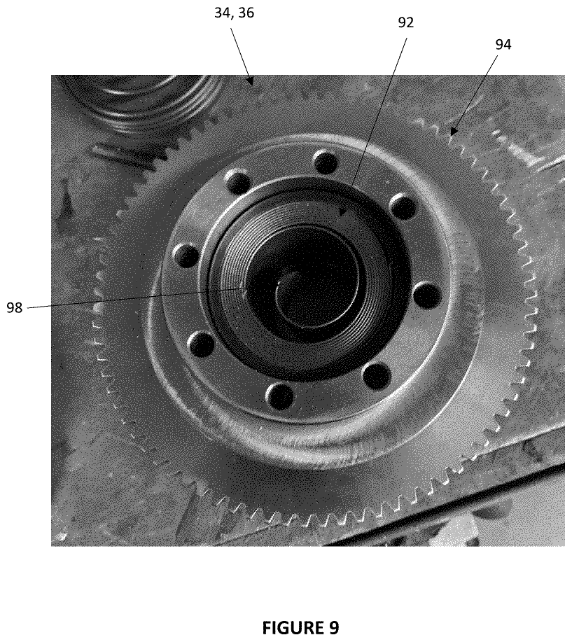

FIG. 9 shows one of the main spring assemblies 34, 36 on its side in order to expose the main spring 92 inside. The main spring 92 includes a tab 98 that is attached to the main shaft 30 by sliding into a slot in the main shaft.

As the conical transfer spring 42 is compressed and wound tight as shown in FIG. 3 because the one-way bearing stopped rotation in the direction that the self-reversing screw barrel mechanism 38 is rotating, the conical transfer spring 42 eventually reaches a point in time where it is wound completely. At this time, the self-reversing screw barrel mechanism 38 has still not reached the end of its groove in the pin 88 and it continues to rotate. At this time, the main spring 92 now begins to wind around the main shaft 30. Energy from the rotation of the main shaft 30 is being stored in the conical transfer spring 42 and the main spring 92.

When the self-reversing screw barrel mechanism 38 finally reaches the end of its length and beings to move in the opposite direction, the one-way bearing 90 is now free to rotate on the main shaft 30. The energy stored in the conical transfer spring 42 and the main spring 92 is now released as the one-way bearing now freely rotates in the opposite direction of the main shaft 30. The conical transfer spring 42 and the main spring 92 direct their energy to the main spring assemblies 34, 36 which cause the outer gear 94 to rapidly rotate, which causes the transfer gear 96 to rotate which causes a shaft 100 connected to the alternator 16 to rotate and generate electricity.

The description above shows what happens at just one end of the system as the self-reversing screw barrel mechanism 38 is moving in one direction. By having a conical transfer spring and main spring assembly on each end of the main shaft and on opposite sides of the self-reversing screw barrel mechanism 38, one side of the system is always releasing energy to the alternator 16 while the opposite end is storing the energy.

It should be apparent now that even though the main shaft 30 is only rotating in a single direction, the self-reversing screw barrel mechanism 38 is able to move back and forth between the main spring assemblies 34, 36, because of the splines 90, 92 inside the self-reversing screw barrel mechanism.

The end result of the movement of the self-reversing screw barrel mechanism 38 and the winding and unwinding of the conical springs 40, 42, is that the main shaft 30 is able to provide continuous rotation of the alternator 16, and thereby continuously generate electricity. This is shown as the alternator coupling shaft 100 that is coupled to the alternator 16.

It should be noted that the speed of the shaft 100 may vary. The main springs 92 and the conical transfer springs 40, 42 will be rapidly discharging their energy onto the shaft 100 and then slow down. Nevertheless, the alternator 16 is kept in constant motion by momentum of the alternator 16.

Thus, the rack and pinion assembly 12 receives linear work from the vehicle suspension system 10 and converts the linear work to rotary work that is captured by the rotational movement capture system 14 which in turn rotates the alternator 16.

This document now examines some of the components of the first embodiment in more detail in order to understand how they operate to provide the desired functionality of generating electrical energy for use by a vehicle.

In FIG. 3, it is noted that if the self-reversing screw barrel mechanism 38 is moving towards the second main spring assembly 36, then the first conical spring 40 is unwinding and the second conical spring 42 is being wound up. When the reversing screw barrel mechanism 38 reaches the second main spring assembly 36, then the mechanism reverses direction and moves towards the first main spring assembly 34. When this happens, then the first conical spring 40 is winding up and the second conical spring 42 is unwinding.

The self-reversing screw barrel mechanism 38 may be a hollow structure that has splines 82 that engage the splines 80 on the main shaft 30. The self-reversing screw barrel mechanism 38 is an object that is free to move longitudinally up and down the splines 80 of the main shaft 30.

The self-reversing screw barrel mechanism 38 has the conical springs 40, 42 attached at each end of the mechanism. The conical springs 40, 42 may be inside a cylindrical housing that when turned, tightens, and eventually stops and starts winding the main springs 92. As the main shaft 30 turns, the splines on the main shaft turns the self-reversing screw barrel mechanism 38 and thus causes motion of the mechanism from left to right and then from right back to the left. In this alternating motion, the first embodiment provides continuous rotation of the alternator 16 which in turn generates electrical energy.

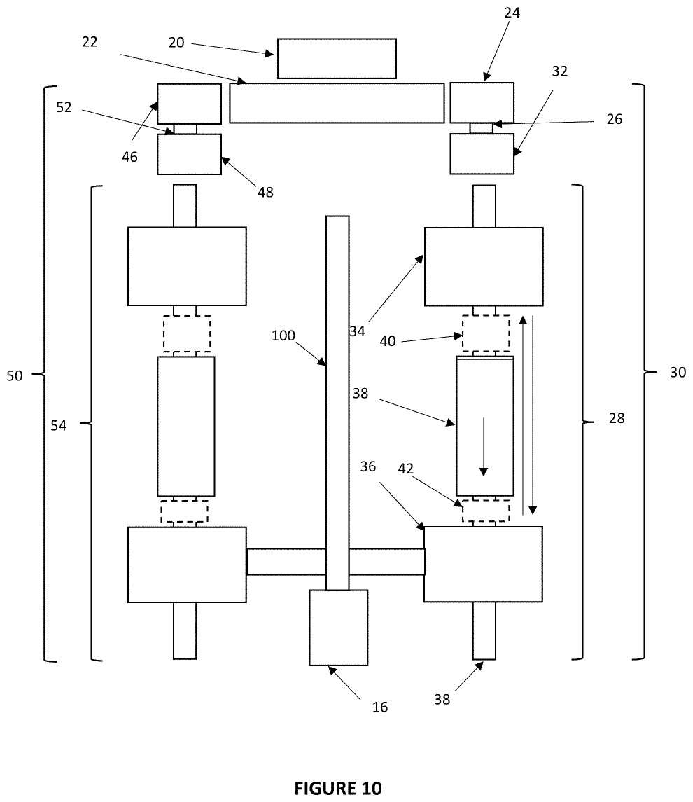

It should now be apparent that the first embodiment described in FIG. 3 has only captured half of the kinetic energy that is available from the up-and-down motion of the vehicle suspension system 10. In order to maximize the efficiency of the present invention, in a second embodiment of the invention shown in a block diagram in FIG. 10, while the first embodiment is coupled to the vehicle suspension system in order to capture energy from, for example, the upward movement of the linear gear 20, a second embodiment of the invention is designed to capture the energy from the downward movement of the same linear gear 20.

This second embodiment may use the components shown in FIG. 3 while adding additional components. Thus, the linear gear is still represented by the item 20. The vehicle suspension system 10 is coupled to the linear gear 20 of the rack and pinion assembly 12. The linear gear 20 thus may travel the same distance up and down as the vehicle suspension system 10 while the vehicle is moving down a road. The linear gear 20 in turn is causing the circular gear 22 to rotate in both directions.

FIG. 3 shows what happens using the first embodiment which may only be capturing kinetic energy from half of the movement of the vehicle suspension system 10. This is because the second portion 28 of the main shaft 30 is only moving half of the time that the vehicle suspension system 10 is moving because of the use of the one-way bearing 32. But the circular gear 22 may also in turn be coupled to the output gear 46 at the same time as it is coupled to the output gear 24. While the gear ratio between the circular gear 22 and the output gear 46 may vary, the selected ratio in the second embodiment is 1:5 and then 5:1.

In this second embodiment shown in FIG. 10, the second output gear 46 is on a different side of the circular gear 22. The output gear 46 is coupled to a second main shaft 50 that is coupled to a one-way bearing 48. However, an important distinction is that the one-way bearing 48 is turning in the direction that is opposite to the direction that the one-way bearing 32 is turning. Thus, while the one-way bearing 32 is capturing kinetic energy from the vehicle suspension system 10 moving in one direction, the one-way bearing 50 is capturing the kinetic energy when the vehicle suspension system 10 is moving in the opposite direction.

Accordingly, the first and second embodiments combined are now capturing kinetic energy when the vehicle suspension system 10 is moving both up and down, and thus capturing the kinetic energy from movements of the linear gear 20 in both directions instead of just one.

To complete the description of the components that are added to the first embodiment in the second embodiment, the output gear 46 may be disposed on a first portion 52 of a main shaft 50. The first portion 52 of the main shaft 50 is able to rotate in both directions. The first portion 52 is then coupled to a second (and longer) portion 54 of the main shaft 50 using a coupling that is the one-way bearing 48.

Accordingly, while the output gear 46 and the first portion 52 of the main shaft 50 will rotate in both directions, the second portion 54 of the main shaft 50 will only rotate in one direction. This means that the up-and-down motion of the vehicle suspension system 10 is only causing the main shaft 50 to rotate when the vehicle suspension system 10 moves up or when it moves down, but not from movement in both directions. However, the main shaft 50 is now capturing rotational movement that is in the opposite direction of the main shaft 30.

It is noted that the alternator 16 may be a double shaft alternator that may receive input from the main shaft 30 and the main shaft 50 at the same time.

While the first and second embodiments of the invention teach a system of springs and a self-reversing mechanism for maintaining a constant motion of an alternator in order to generate electricity, it is noted that the system and method shown may not be the system selected for performing the desired function. Accordingly, it should be considered to be an aspect of the embodiments of the invention that there may be another means for maintaining a constant motion of an alternator in order to generate electricity. Accordingly, this aspect of the invention may be considered to be a novel aspect of the invention, and thus the scope of the invention may include other means for maintaining a constant motion of an alternator in order to generate electricity. These other means include electromagnetic, hydraulic, pneumatic, and any other systems that are capable of performing the same functions as the first and second embodiments.

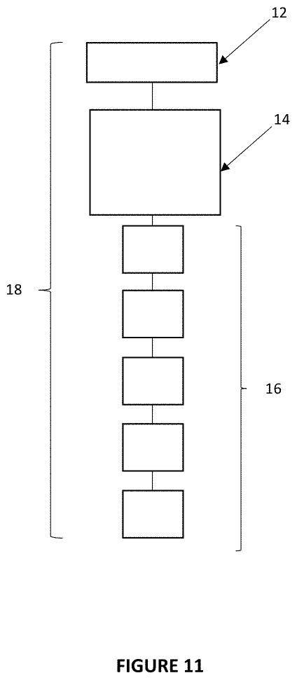

Another aspect of the embodiments is shown in FIG. 11. FIG. 11 shows that a plurality of alternators 16 may be nested or coupled to each other in series in order to increase electrical output of the embodiments of the invention. These alternators 16 may be coupled to the rack and pinion system 12 and the rotational movement capture system 14 to form the regenerative energy system 18.

For example, if each of the alternators 16 shown in FIG. 11 is capable of generating 48 volts, then five alternators in series would generate 240 volts. It should be understood that more or less alternators 16 may be placed in series, and the number should not be considered as a limitation of the invention.

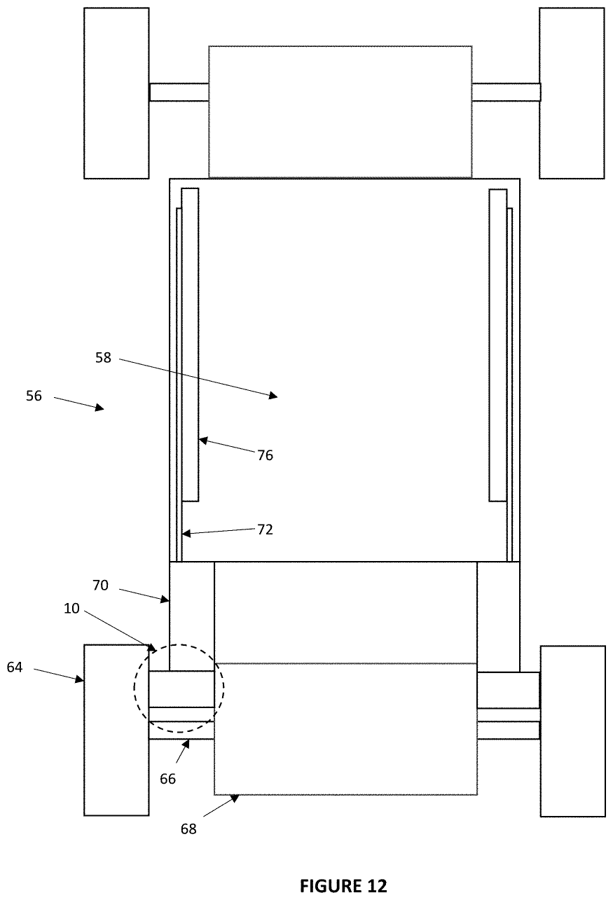

To better understand how the first and second embodiments of the invention might be used, FIG. 12 is a top view of a vehicle chassis 56 or frame without any of the vehicle shell disposed on top of the chassis. This outline of the components of the vehicle chassis 56 an electric vehicle should not be considered as complete but instead illustrating some of the components of a vehicle that are used in the regenerative energy system 18.

FIG. 12 shows the vehicle chassis 56 having four wheels 64, an axle 66 for each wheel, and a motor 68 at the front and back ends of the chassis. Each wheel 64 may have its own independent motor 68 or a motor may be provided for the front wheels 64 and another for the back wheels 64.

The vehicle chassis 56 as shown may also include a middle chassis section 58. The middle chassis section 58 may provide a supporting structure for the embodiments of the invention. For example, the up and down movement of the vehicle suspension system 10 is captured within a housing 70. The housing 70 may be disposed adjacent to a wheel 64 and a portion of a vehicle suspension system 10 that is generally disposed near each of the wheels 64.

There may also be a different housing 70 that is disposed near each different portion of the suspension system 10. For example, another housing 70 may be disposed at all four corners of the vehicle where the vehicle suspension system 10 makes contact with the wheels 64.

The housing 70 includes a shaft 72 that extends outwards from the housing 70. This shaft 72 moves back and forth horizontally as the vehicle suspension system 10 moves up and down. This may be accomplished, for example, using another rack and pinion system 74 (not shown) within the housing 70. In other words, the up and down motion of the vehicle suspension system may be captured by a linear gear of the rack and pinion system 74 and coupled to a pinion gear that moves the shaft 72 back and forth relative to a stationary rack and pinion frame 76 that is mounted on the middle chassis section 58.

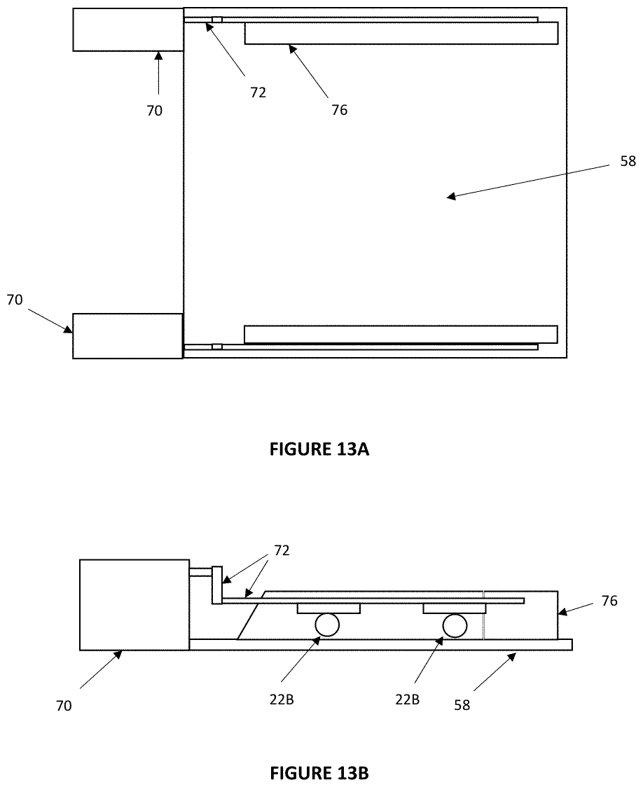

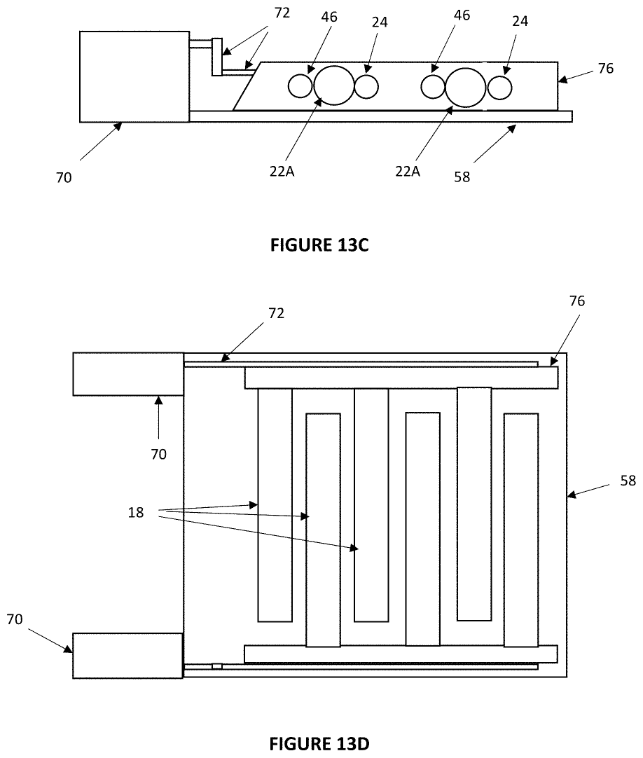

FIG. 13A provides additional detail for the embodiments of the invention. The middle chassis section 58 may provide a support structure for the regenerative energy system 18. In the embodiment shown in FIG. 13A, the middle chassis section 58 and the housing 70 are shown relatively close to each other so that the shaft 72 can reach the rack and pinion frame 76.

FIG. 13B is a profile view of top view of FIG. 13A. FIG. 13B shows the housing 70, and the shaft 72 which extends outwards from the housing. The shaft includes a right angle that brings the shaft down to the rack and pinion frame 76.

On an outer side of the rack and pinion frame 76, the outer circular gear 22B is disposed under and meshes gear teeth with a portion of the shaft 72. Furthermore, in this embodiment, more than one outer circular gear 22B may be disposed in the wall of the rack and pinion frame 76. Thus, a plurality of regenerative energy systems 18 may be disposed in parallel with each other. It should be understood that many more regenerative energy systems 18 may be disposed in parallel as long as there is space on the middle chassis section 58. Thus, while only two regenerative energy systems 18 are shown in this figure, more may be disposed on the middle chassis section 58 as long as there is room for them.

FIG. 13C shown an inner wall of the rack and pinion frame 76 shown in FIG. 13B. The inner wall of shows the other half of the circular gear 22, which is the outer circular gear 22B. On either side of the outer circular gear 22B are disposed the two output gears 24, 46.

FIG. 13D is another top view of the middle chassis section 58 which shows that there are a plurality of regenerative energy systems 18 disposed on each side of the middle chassis section. In this figure, six regenerative energy systems 18 are shown disposed on the middle chassis section 58. The regenerative energy systems 18 are shown as interleaved so that a plurality of alternators may be disposed in series as shown in FIG. 11.

It should be understood that the regenerative energy systems 18 may be disposed in any desired manner that will allow them to fit on both sides of the middle chassis section 58. Accordingly, the arrangement of the regenerative energy systems 18 should not be considered as a limiting factor on the invention or the claims.

In another aspect of the embodiments of the invention, the electrical energy that is being captured by the embodiments of the invention may be immediately used or it may be stored for later use. Accordingly, storage of the electrical energy may also serve as a novel aspect of the invention. It is the reality of electrical vehicles that they must have large batteries in order to store a sufficient amount of energy in order to travel an adequate distance before needing to be recharged. However, not all travel draws the same amount of energy from the batteries.

For example, terrain that includes hills may put a significant strain on the batteries as more power is needed by a motor to move a vehicle uphill, especially when the vehicle is a relatively heavy one as compared to a passenger vehicle. While larger vehicles such as trucks may have more room for larger batteries, there is still a finite amount of space available.

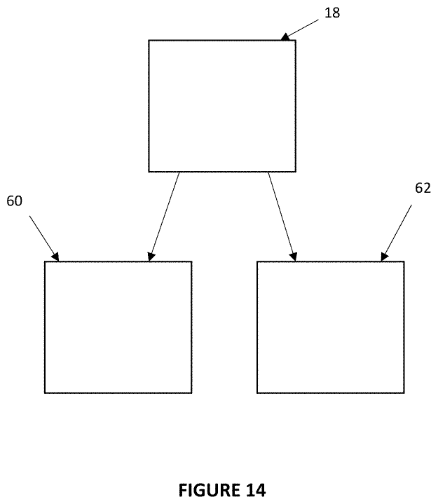

Accordingly, as shown in FIG. 14, another aspect of the embodiments of the invention may also include a specific utilization of the electrical energy that is being generated by the embodiments of the invention. Specifically, it is another aspect of the invention that the electrical energy generated by the regenerative energy system 18 may be stored in a supercapacitor 60 instead of to a battery 62 of the vehicle. Alternatively, the electrical energy may be directed only to the battery 62. In another alternative embodiment, the electrical energy may be directed to both the supercapacitor 60 and the battery 62.

The energy stored in the supercapacitor 60 may be accessed when a vehicle is trying to ascend a hill. Accordingly, it may be recommended that the electrical energy stored in the supercapacitor 60 be accessed when trying to climb a hill because the supercapacitor may be drained more rapidly than energy from the battery 62 and may thus help a vehicle to maintain speed or to even accelerate up a hill. In other words, the supercapacitor 60 may be capable of a faster rate of discharge to a motor as compared to the battery 62, and thus may be called upon for bursts of energy when it is needed.

Another aspect of the invention should be understood regarding the alternator 16 of the regenerative energy system 18. While a stock alternator may be used, the alternator may also be a customized part that generates a greater amount of voltage than standard vehicle alternators. Furthermore, the alternator may be replaced with a generator, a stepper motor, or a brushless motor. What is important is that the function of the alternator be provided in the regenerative energy system 18.

While the embodiments of the invention above are directed to a regenerative energy system that is coupled to a vehicle suspension system, it should be understood that there are other sources of movement that may be utilized to generate electricity using a similar regenerative energy system.

For example, wave action may be characterized as a back and forth linear motion. This linear motion may be tapped by a rack and pinion system similar to the way that the linear motion of a vehicle suspension system is tapped. Accordingly, the regenerative energy system of the present invention only needs to be coupled to a continuous source of movement in order to operate.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A regenerative energy system configured to capture energy from linear motion, said system comprising:
a gear assembly, wherein the gear assembly receives input from a linear motion source and creates rotational motion, and wherein the rotational motion is coupled to a main shaft;
the main shaft which is coupled at one end to the gear assembly and at an opposite end to a one-way bearing, wherein the main shaft only rotates in one direction after the one-way bearing;
a rotational movement capture system that is coupled to the main shaft to capture energy therefrom;
an alternator that is also coupled to the main shaft and which receives energy from the rotational movement capture system; and
wherein the gear assembly receives linear motion from the linear motion source, thereby causing the main shaft to rotate in a single direction, wherein the rotational movement capture system is coupled to the main shaft and thereby continuously rotating the alternator in the single direction.

2. The regenerative energy system as defined in claim 1 wherein the gear assembly is further comprised of a rack and pinion gear assembly;

3. The regenerative energy system as defined in claim 2 wherein the main shaft is coupled at one end to the gear assembly and at an opposite end to the one-way bearing, wherein the main shaft includes a first portion that is free to rotate in both directions before it reaches the one-way bearing, but which includes a second portion that only rotates in one direction after the one-way bearing.

4. The regenerative energy system as defined in claim 3 wherein the rotational movement capture system further comprises:
a first spring assembly coupled to one end of the main shaft;
a second spring assembly coupled to an opposite end of the main shaft;
a self-reversing screw barrel mechanism having a conical spring coupled to each end thereof and coupled to the main shaft and disposed between the first spring assembly and the second spring assembly; and
wherein the gear assembly receives linear motion from the linear motion source, thereby causing the main shaft to force the self-reversing barrel mechanism to move back and forth between the first spring assembly and the second spring assembly, and thereby causing winding and unwinding of the conical springs coupled to the self-reversing screw barrel mechanism, and thereby generating rotational motion in a single direction to an alternator.

5. The regenerative energy system as defined in claim 4 wherein the system further comprises:
an input gear coupled to the gear assembly; and
an output gear coupled to the input gear, wherein the output gear is coupled to the first portion of the main shaft.

6. The regenerative energy system as defined in claim 5 wherein the self-reversing screw mechanism is further comprised of a self-reversing screw barrel.

7. The regenerative energy system as defined in claim 6 wherein the linear motion source is selected from the group of linear motion sources comprised of a vehicle suspension system and waves on a body of water.

8. A regenerative energy system configured to capture energy from linear motion, said system comprising:
a rack and pinion gear assembly, wherein the rack receives input from a linear motion source and is coupled to the pinion gear, and wherein the pinion gear is coupled to a main shaft;
the main shaft which is coupled to the pinion gear and to a one-way bearing, wherein the main shaft includes a first portion that is free to rotate in both directions before it reaches the one-way bearing, but which includes a second portion that only rotates in one direction after the one-way bearing;
a first spring assembly coupled to one end of the main shaft;
a second spring assembly coupled to an opposite end of the main shaft;
a self-reversing screw barrel mechanism having a conical spring coupled to each end thereof and coupled to the main shaft and disposed between the first spring assembly and the second spring assembly; and
wherein the rack and pinion gear assembly receives linear motion from the linear motion source, thereby causing the main shaft to force the self-reversing barrel mechanism to move back and forth between the first spring assembly and the second spring assembly, and thereby causing winding and unwinding of the conical springs coupled to the self-reversing screw barrel mechanism, and thereby generate rotational in a single direction to an alternator.

9. The regenerative energy system as defined in claim 8 wherein the system further comprises:
an input gear coupled to the pinion; and
an output gear coupled to the input gear, wherein the output gear is coupled to the first portion of the main shaft.

10. The regenerative energy system as defined in claim 9 wherein the self-reversing screw mechanism is further comprised of a self-reversing screw barrel.

11. The regenerative energy system as defined in claim 10 wherein the linear motion source is selected from the group of linear motion sources comprised of a vehicle suspension system and waves on a body of water.

12. A method for capturing energy from linear motion, said method comprising:
providing a gear assembly, wherein the gear assembly receives input from a linear motion source and creates rotational motion;
coupling the rotational motion to a main shaft;
providing the main shaft which is coupled at one end to the gear assembly and at an opposite end to a one-way bearing;
rotating the main shaft in one direction after the one-way bearing;
providing a rotational movement capture system that is coupled to the main shaft to capture energy therefrom;
providing an alternator that is also coupled to the main shaft and which receives energy from the rotational movement capture system;
receiving linear movement from the linear motion source at the gear assembly;
converting the linear movement to rotational movement of the gear assembly;
rotating the main shaft in a single direction;
capturing the rotational movement of the main shaft using the rotational movement capture system; and
continuously rotating the alternator in a single direction to thereby generate electricity.

13. The method as defined in claim 12 wherein the method further comprises converting linear motion to rotation using a rack and pinion gear assembly.

14. The method as defined in claim 13 wherein the method further comprises:
coupling the main shaft at one end to the gear assembly and at an opposite end to the one-way bearing, rotating a first portion of the main shaft that is free to rotate in both directions before it reaches the one-way bearing; and
rotating a second portion of the main shaft that only rotates in one direction after the one-way bearing.

15. The method as defined in claim 14 wherein the method further comprises:
providing a first spring assembly coupled to one end of the main shaft;
providing a second spring assembly coupled to an opposite end of the main shaft;
providing a self-reversing screw barrel mechanism having a conical spring coupled to each end thereof and coupled to the main shaft and disposed between the first spring assembly and the second spring assembly;
receiving linear motion from the linear motion source at the gear assembly;
forcing the self-reversing barrel mechanism to move back and forth between the first spring assembly and the second spring assembly;
forcing winding and unwinding of the conical springs coupled to the self-reversing screw barrel mechanism; and
generating rotational motion in a single direction to an alternator to thereby generate electricity.
